(19) United States
(12) Patent Application Publication
(10) Pub. No.: US 2014/0095275 A1
(43) Pub. Date: Apr. 3, 2014

(54) PROMOTIONAL CODE DISTRIBUTION USING MOBILE DEVICES

(71) Applicants: Jason R. Fosback, Edmonds, WA (US); Ricardo D. Cortes, Los Gatos, CA (US)

(72) Inventors: Jason R. Fosback, Edmonds, WA (US); Ricardo D. Cortes, Los Gatos, CA (US)

(21) Appl. No.: 13/632,033

(22) Filed: Sep. 30, 2012

(51) Int. Cl. G06Q 30/02; H04W 4/00

(52) U.S. Cl. CPC G06Q 30/0207; H04W 4/008
USPC 705/14.1

(57) ABSTRACT

Improved systems and methods to distribute codes, such as promotional codes, are disclosed. The improved systems and methods can enable recipients to acquire a downloadable asset from a networked-based distribution system. In one embodiment, through use of mobile devices, a code can be delivered and redeemed to acquire a downloadable asset with minimal burden to developer and recipient. In one implementation, delivery of the code to the recipient mobile device can be facilitated by providing the mobile device of the developer closely proximate to the mobile device of the recipient.

### BACKGROUND OF THE INVENTION

Conventionally, after a application program has been developed and is ready for distribution, it can be uploaded to a online store, such as the iTunes App Store from Apple Inc., for distribution. Typically, a back-end system, such as iTunes Connect from Apple Inc., can be used by the application developer to submit the application program and to configure distribution parameters.

Primarily for marketing purposes, the back-end system can allow a developer to obtain one or more promotional codes. For example, iTunes Connect allows a developer to obtain fifty (50) promotional codes. The developer can then operate to distribute these codes to product reviewers, friends, etc. however desired. The recipients can then manually redeem the promotional codes via the online store and thereby receive the application program without cost.

Unfortunately, however, the distribution and use of promotional codes requires a significant amount of time and various user operations to acquire an application program using a promotional code.

### SUMMARY

Improved systems and methods to distribute codes, such as promotional codes, are disclosed. The improved systems and methods can enable recipients to acquire a downloadable asset from a networked-based distribution system. In one embodiment, through use of mobile devices, a code can be delivered and redeemed to acquire a downloadable asset with minimal burden to developer and recipient. In one implementation, delivery of the code to the recipient mobile device can be facilitated by providing the mobile device of the developer closely proximate to the mobile device of the recipient.

The invention can be implemented in numerous ways, including as a method, system, device, apparatus (including computer readable medium and graphical user interface). Several embodiments of the invention are discussed below.

As a method for distribution of application programs, one embodiment of the invention can, for example, include at least the operations of: submitting an application program to a network-based distribution system, the application program being submitted by a developer; obtaining, from the network-based distribution system, a code for distributing a copy of the application program to a recipient; and initiating wireless delivery of the code from a developer mobile device to the recipient mobile device, the initiating including at least detecting that the developer mobile device and to the recipient mobile device are physically proximate to one another.

As a method for distribution of application programs, one embodiment of the invention can, for example, include at least the operations of: submitting an application program to a network-based distribution system, the application program being submitted by a developer; obtaining, from the network-based distribution system, a code for distributing a copy of the application program to a recipient; and initiating wireless delivery of the code from a developer mobile device to the recipient mobile device, the initiating including at least physically bumping the developer mobile device with the recipient mobile device.

As a method for distribution of digital asset to a mobile device, one embodiment of the invention can, for example, include at least the operations of: detecting that a developer mobile device is physically proximate to a recipient mobile device, the developer mobile device being associated with a developer of an application program; receiving a code from a developer of an application program, where the developer mobile device is or has been physically proximate to the recipient mobile device; determining whether a recipient agrees to receive the code for access to a copy of the application program being provided by the developer; receiving and storing the code at the recipient mobile device provided that the determining determines that the recipient has agreed to receive the code associated with the application program and provided that the detecting detects that the developer mobile device and the recipient mobile device are or were physically proximate to each other; subsequently facilitating redemption of the code with the network-based distribution system to acquire the application program; and thereafter receiving and installing the application program at the recipient mobile device.

As a method for distribution of digital asset to a mobile device, one embodiment of the invention can, for example, include at least the operations of: receiving a physical bump at recipient mobile device from a developer mobile device associated with a developer of an application program; determining that a recipient has an account with the network-based distribution system; determining whether the recipient agrees to receive a promotional code being provided by the developer; storing the promotional code at the recipient mobile device; subsequently facilitating redemption of the promotional code with the network-based distribution system, provided that the recipient has an account with the network-based distribution system, and provided that the recipient has agreed to receive the promotional code; and thereafter receiving and installing the application program at the recipient mobile device.

As a non-transitory computer readable medium including at least computer program code stored thereon for distribution of application programs, one embodiment of the invention can, for example, include at least: computer program code for submitting an application program to a network-based distribution system, the application program being submitted by a developer; computer program code for obtaining, from the network-based distribution system, a code for distributing a copy of the application program to a recipient; and computer program code for initiating wireless delivery of the code from a developer mobile device to the recipient mobile device, the initiating including at least detecting that the developer mobile device and to the recipient mobile device are physically proximate to one another.

As a non-transitory computer readable medium including at least computer program code stored thereon for distribution of digital asset to a mobile device, one embodiment of the invention can, for example, include at least: computer program code for detecting that a developer mobile device is physically proximate to a recipient mobile device, the developer mobile device being associated with a developer of an application program; computer program code for receiving a code from a developer of an application program, where the developer mobile device is or has been physically proximate to the recipient mobile device; computer program code for determining whether a recipient agrees to receive the code for access to a copy of the application program being provided by the developer; computer program code for receiving and storing the code at the recipient mobile device provided that the determining determines that the recipient has agreed to receive the code associated with the application program and provided that the detecting detects that the developer mobile device and the recipient mobile device are or were physically proximate to each other; computer program code for subsequently facilitating redemption of the code with the network-based distribution system to acquire the application program; and computer program code for receiving and installing the application program at the recipient mobile device.

Other aspects and advantages of embodiment of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a diagram illustrating states associated with an application management system according to one embodiment.

FIG. 2 illustrates an application distribution system according to one embodiment.

FIG. 3A-3D illustrate the application distribution system illustrated in FIG. 2 in different states.

FIG. 4A is a flow diagram of a promotional code access process according to one embodiment.

FIG. 4B is a flow diagram illustrating a recipient identification process according to one embodiment.

FIG. 5 is a flow diagram illustrating a promotional code delivery process according to one embodiment.

FIG. 6 is a flow diagram of a promotional code redemption process according to one embodiment.

### DETAILED DESCRIPTION OF EMBODIMENTS OF THE INVENTION

Improved systems and methods to distribute codes, such as promotional codes, are disclosed. The improved systems and methods can enable recipients to acquire a downloadable asset from a networked-based distribution system. In one embodiment, through use of mobile devices, a code can be delivered and redeemed to acquire a downloadable asset with minimal burden to developer and recipient. In one implementation, delivery of the code to the recipient mobile device can be facilitated by providing the mobile device of the developer closely proximate to the mobile device of the recipient.

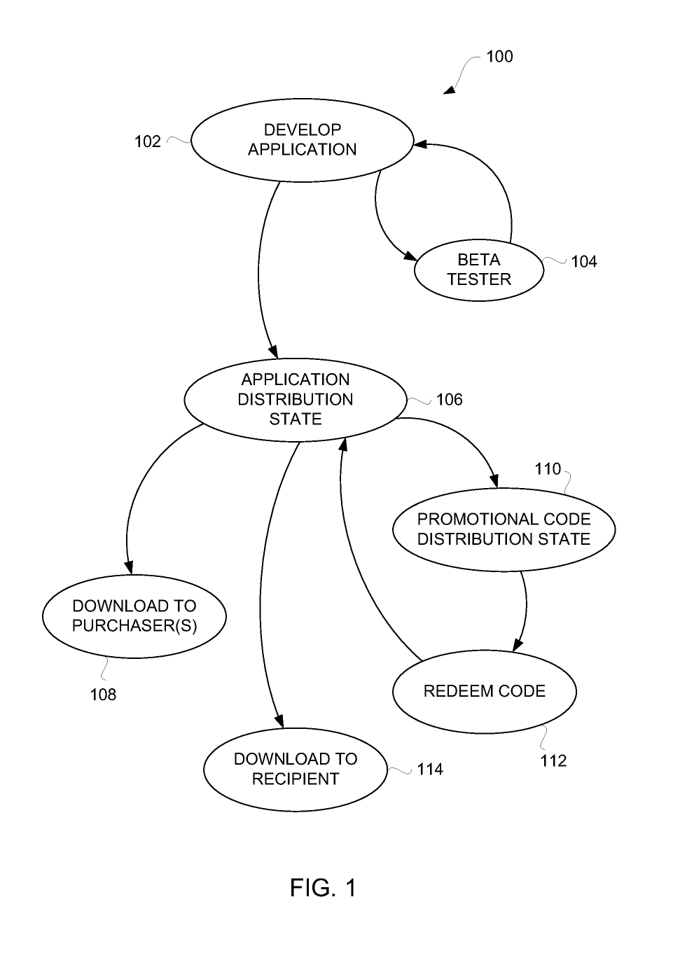

Embodiments of the invention are discussed below with reference to FIGS. 1-6. However, those skilled in the art will readily appreciate that the detailed description given herein with respect to these figures is for explanatory purposes as the invention extends beyond these limited embodiments.

FIG. 1 is a diagram illustrating states associated with an application management system 100 according to one embodiment. The application management system 100 can serve to manage various states of operation from development to distribution of an application program.

Initially, the application management system 100 can be in a develop application state 102. In this state, a developer can operate with or without the assistance of the application management system 100 to develop an application program. An application program is a computer program that is operable on a computing device. Often, the application program is designed to operate on a particular hardware and software platform (e.g., iOS, android, Windows, etc.).

Once an application program has been developed, the application program can undergo beta testing. In such case, the application management system 100 can assist in the transition from the develop application state 102 to a beta test state 104. At the beta test state 104, beta testing can be carried out by one or more testers. The beta testers typically operate the developed application program on their computing device, which can be a mobile computing device, to evaluate the application program for defects or “bugs”.

Following the completion of beta testing, the application management system 100 can assist in the transition from the beta test state 104 back to the develop application state 102 where the developer can further modify the application program in light of the beta testing. Thereafter, when the developer believes that the application program has been completely developed and thus is ready for distribution, the developer can submit the application program to the application management system 100 for distribution. In one embodiment, the application management system 100 can be associated with an online store from which various application programs, including the developed application program, can be purchased and then downloaded to various purchasers.

In the case in which the application program has been purchased (e.g., via an online store), the application management system 200 can assist in the transition from the application distribution state 106 to a download to purchaser state 108. At the download to purchaser state 108, the application program can be downloaded to a computing device (e.g., a mobile device) associated with the purchaser.

On the other hand, from the application distribution state 106, the developer can obtain promotional codes that can be distributed to recipients. In this situation, the application management system 100 can assist in the transition from the application distribution state 106 to a promotional code distribution state 110 where a promotional code for the application program can be distributed to a recipient. After the promotional code has been distributed to the recipient, the recipient can operate to redeem the code and thus acquire the application program. In this regard, when the recipient desires to redeem the promotional code it has received, the application management system 100 can assist in the transition from the promotional code distribution state 110 to a redeem code state 112 in which the recipient is able to redeem the promotional code. The redemption of the promotional code for the recipient includes the scenario where the recipient's mobile device operates to itself submit the promotional code, while requiring letter or no assistance from the recipient. Typically, the redeem code would be submitted by the recipient's mobile device to the application management system 100, which could then transition from the redeem code state 112 to the application distribution state 106 where the redeem code could be approved and then the application program would the slated for download to the recipient. In such case, the application management system 100 can facilitate the transition from the application distribution state 106 to a download to recipient state 114 wherein the application program would be downloaded to the recipient.

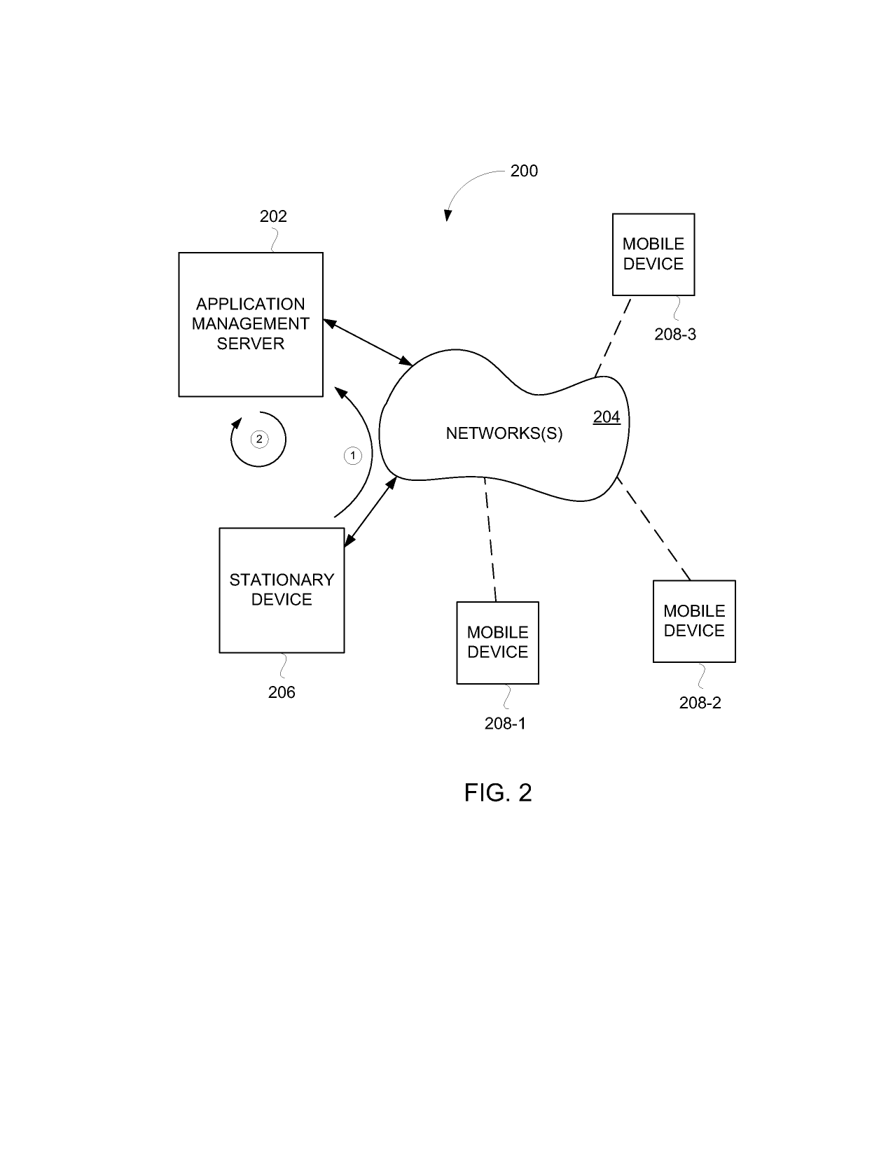

FIG. 2 illustrates an application distribution system 200 according to one embodiment. The application distribution system 200 can include an application management server 202. The application management server 202 can operate to manage submission, storage and distribution of various application programs that have been developed. The application management server 202 can be coupled to one or more networks 204. By way of the networks 204, the application management server 202 is able to communicate or interact with numerous other computing devices. FIG. 2 illustrates various stationary and mobile devices, which are more generally referred to as electronic devices or computing devices. In particular, as illustrated in FIG. 2, the application distribution system 200 depicts a stationary device 206, a first mobile device 208-1, a second mobile device 208-2, and a third mobile device 208-3.

A developer of an application program can operate the stationary device 206 and the first mobile device 208-1. In one scenario, the developer interacts with the stationary device 206 to submit an application program that the developer has created to the application management server 202. The application management server 202 can evaluate the application program in accordance with various rules that govern the submission of application programs. In addition, the application management server 202 can perform or manage a review of the submitted application program (e.g., content or quality review). If the application program passes the various rules as well as the review, the application program can be rendered available for distribution by the application management server 202. For example, the application management server 202 can provide or facilitate rendering the application program available for purchase from an online store. The online store can be hosted by the application management server 202 or another server. While FIG. 2 is described with respect to a single developer submitting a single application program for distribution, it should be understood that the application distribution system 200 can support a large number of developers who each can submit one or more multiple application programs for distribution.

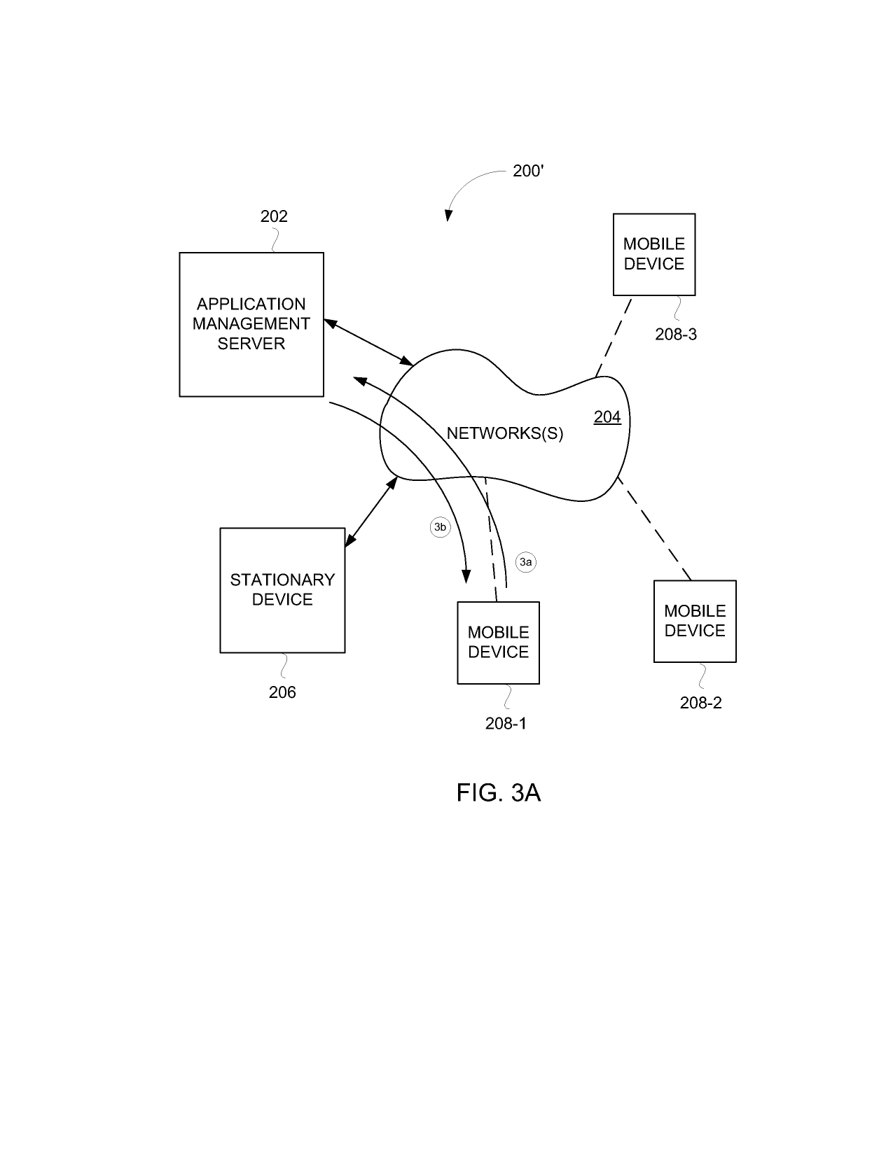

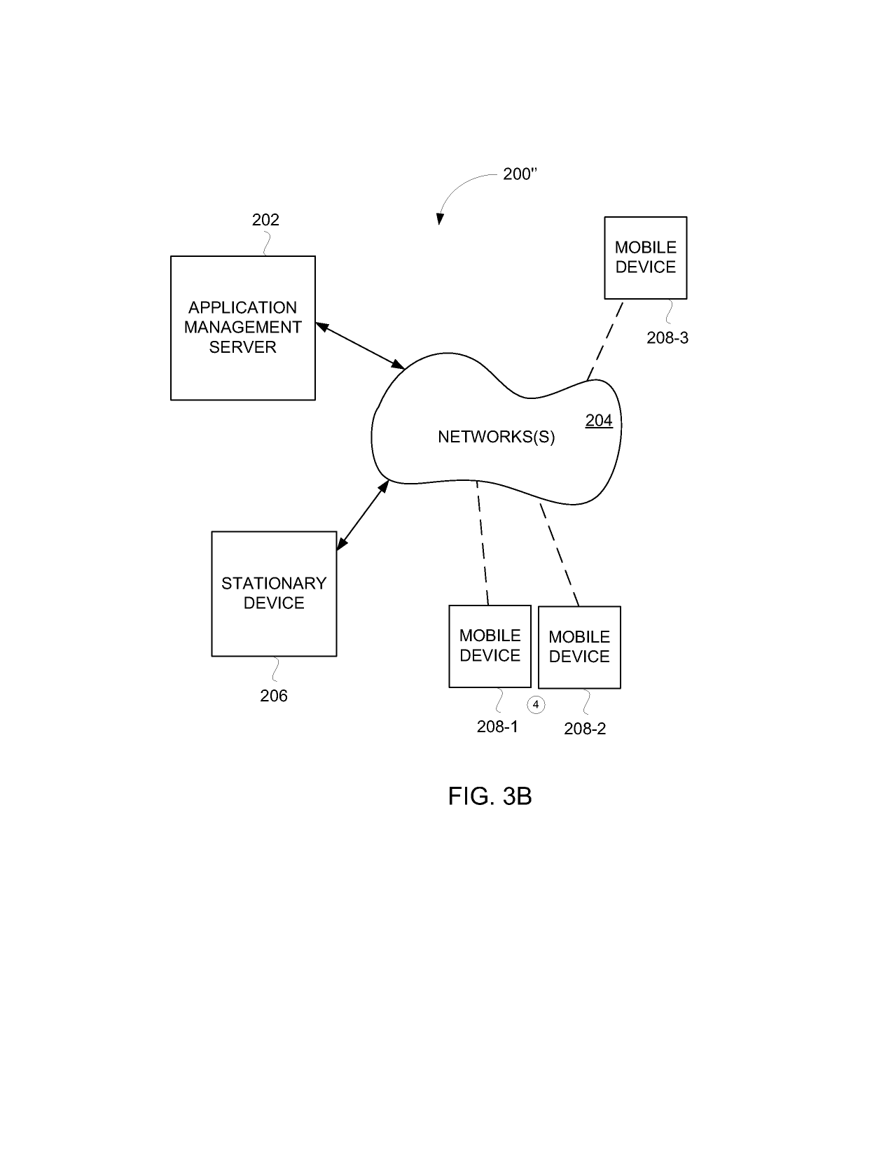

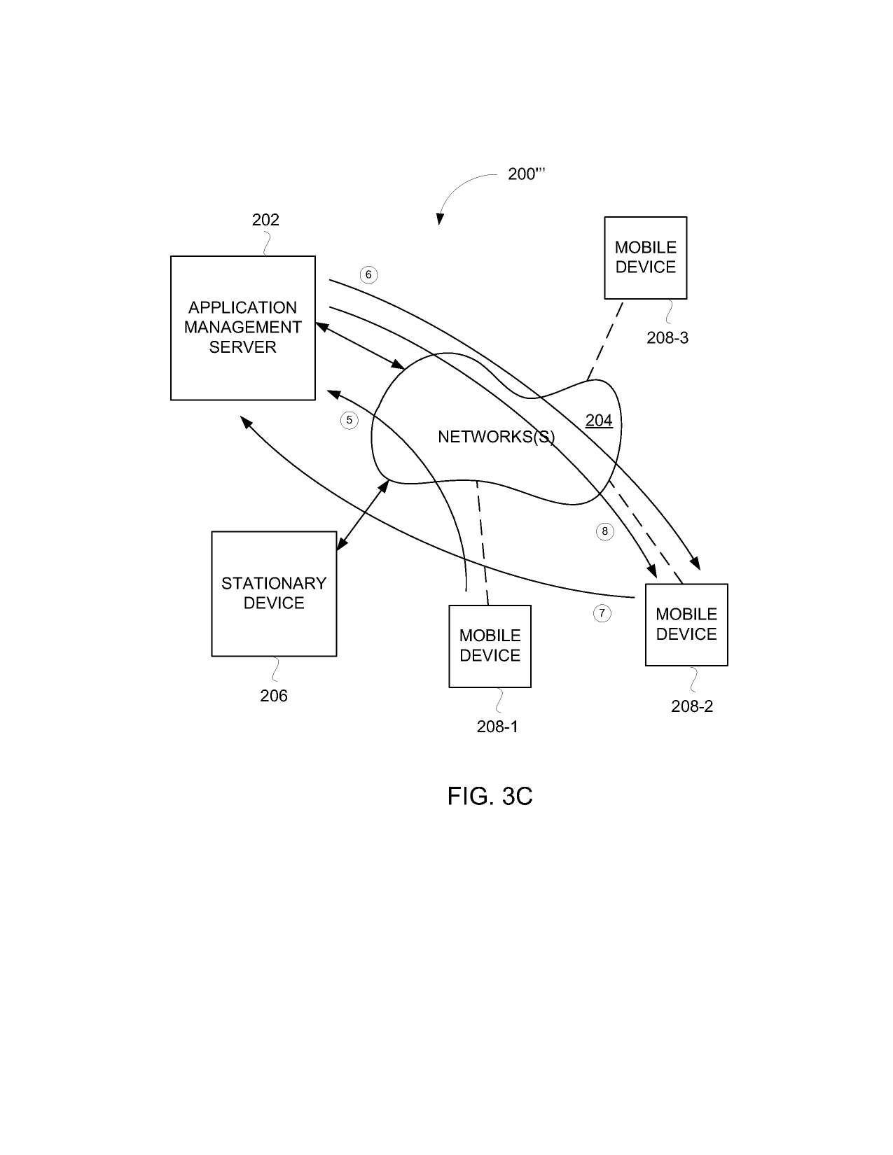

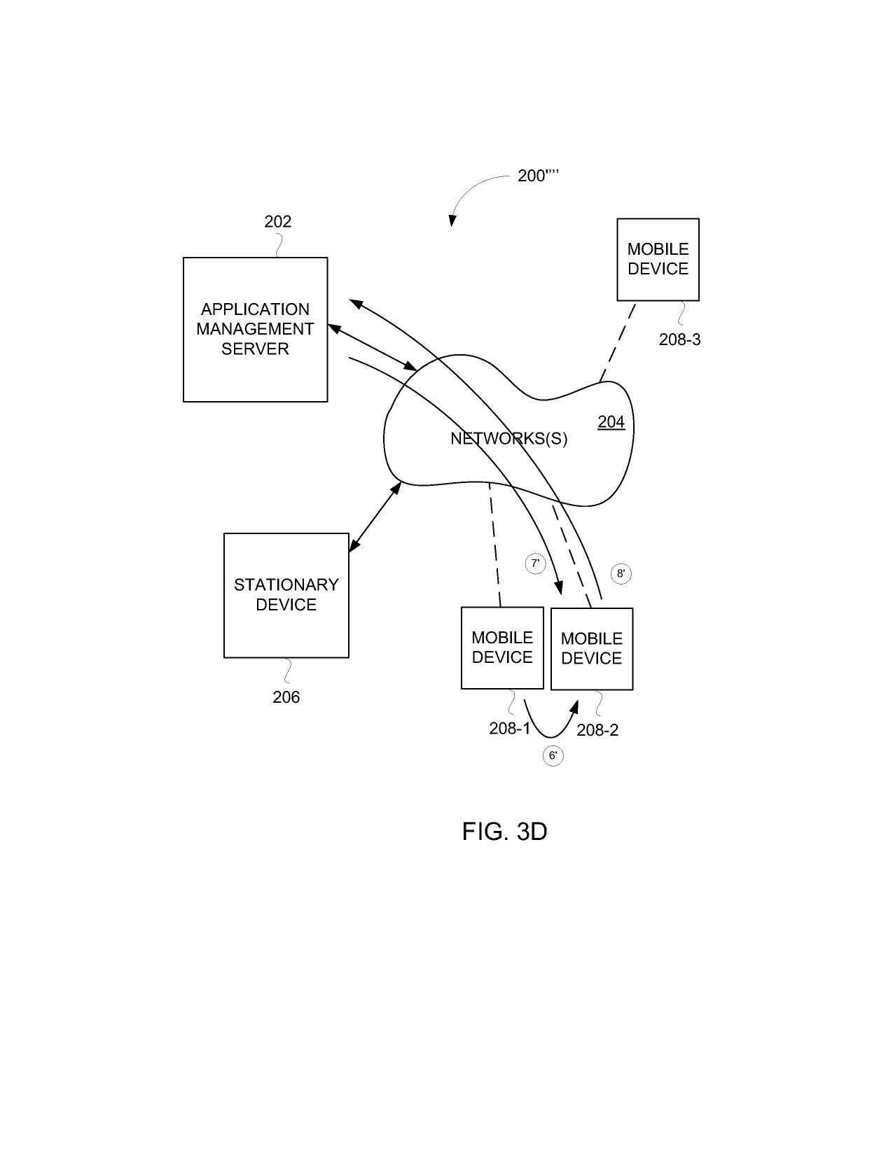

FIG. 3A-3D illustrate the application distribution system 200 illustrated in FIG. 2 in different states. In FIG. 3A, the application distribution system 200′ is depicted with respect to a developer acquiring promotional codes. In particular, the first mobile device 208-1, which is associated with the developer, can be used by the developer to request one or more promotional codes from the application management server 202. Here, the application management server 202 can manage the number and usage of promotional codes by a developer with respect to a particular application program.

In the example illustrated in FIG. 3A, at step 3a, the first mobile device 208-1 sends a request for at least one promotional code to the application management server 202. Then, in step 3b, the application management server 202 sends the at least one promotional code to the first mobile device 208-1. It should be noted that the promotional code is affiliated with a particular application program associated with the developer. Also, it should be noted that the application management server 202 can impose a limit on the number of promotional codes that are available for distribution by the developer for a given application program.

In the example illustrated in FIG. 3B, the first mobile device 208-1 and the second mobile device 208-2 are placed proximate (i.e., near) to one another. In one embodiment, adjacent refers to the two devices either in contact with one another or being separated by no more than one (1) meter. More specifically, in one implementation, the first mobile device 208-1 can be adjacent to the second mobile device 208-2. In one embodiment, adjacent refers to the two devices either in contact with one another or being closely proximate such as being separated by no more than thirty (30) centimeters. In another implementation, the first mobile device 208-1 can be touching to the second mobile device 208-2. Regardless of the degree of proximity, in step 4, with the first mobile device 208-1 and the second mobile device 208-2 placed proximate to one another, the developer utilizing the first mobile device 208-1 can initiate a transfer of a promotional code to the second mobile device 208-2. This can be achieved either with the assistance of the application management server 202 or can be achieved directly from one mobile device to another. In either case, the close proximity (e.g., within thirty (30) centimeters of each other) of the two devices allows the first mobile device 208-1 to acquire information from the second mobile device 208-2 that can be used to authenticate the second mobile device 208-2. For example, the authentication information can include a unique identifier, such as the GUID, for the second mobile device 208-2.

In the example illustrated in FIG. 3C, the first mobile device 208-1 can initiate delivery of a promotional code to the second mobile device 208-2, at step 5. Then, the application management server 202, which receives the request to deliver the promotional code, evaluates the request and determines whether the distribution of the promotional code is permitted. For example, the application management server 202 can operate one or more rules that determine whether a given developer can distribute a promotional code for a given application program. If the promotional code is permitted to be distributed, the application management server 202 can deliver the promotional code to the second mobile device 208-2, at step 6. The information captured from the second mobile device 208-2 at step 4 can be used by the application management server 202 to determine where to deliver the promotional code.

After the second mobile device 208-2 receives the promotional code, the second mobile device 208-2, or its user, can initiate redemption of the promotional code at step 7. The promotional code can be redeemed to the application management server 202. In the event that the application management server 202 determines that the promotional code is a valid code, the application management server 202 can then initiate delivery, at step 8, of an electronic copy of the application program that is associated with the promotional code. Typically, the electronic copy of the application program would be delivered to the second mobile device 208-2 (the device from which the redemption request was made). However, it should be understood that the electronic copy of the application program could alternatively or additionally be delivered to some other electronic device with computing capability that is associated with the user of the second mobile device 208-2.

FIG. 3D illustrates an alternative embodiment for delivery and redemption of a promotional code. In FIG. 3D, the first mobile device 208-1 can operate to deliver a promotional code to the second mobile device 208-2, at step 5′. In this example, the first mobile device 208-1 includes the promotional code, and the close proximity of the second mobile device 208-2 permits the transfer of the promotional code directly from the first mobile device 208-1 to the second mobile device 208-2. Once the second mobile device 208-2 receives and stores the promotional code, the second mobile device 208-2, or its user, can initiate redemption of the promotional code at step 7′. Then, the application management server 202 can process the submission of the promotional code, and determine whether the associated application program is permitted to be distributed to the second mobile device 208-2, which was the device that redeemed the promotional code. If the distribution is permitted by the application management server 202, the application management server 202 can initiate delivery of the application program to the second mobile device 208-2 at step 8′.

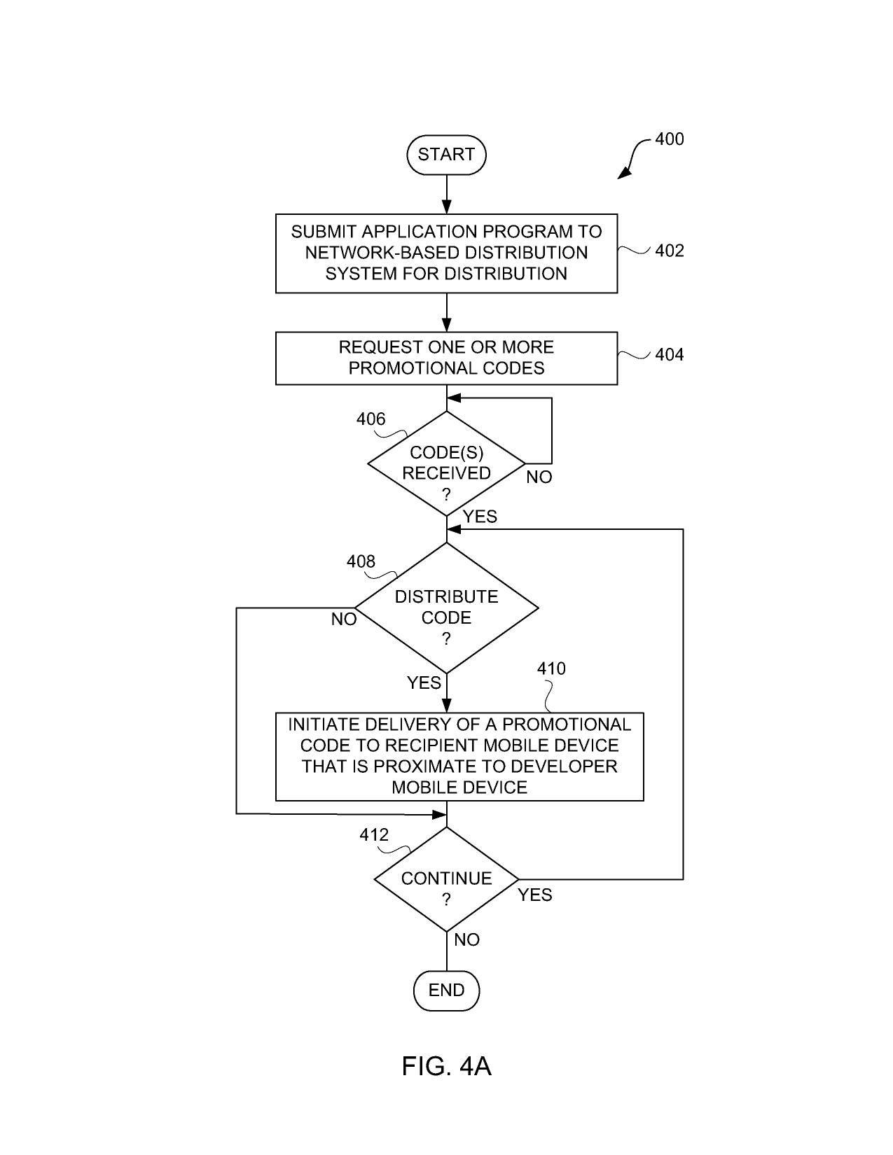

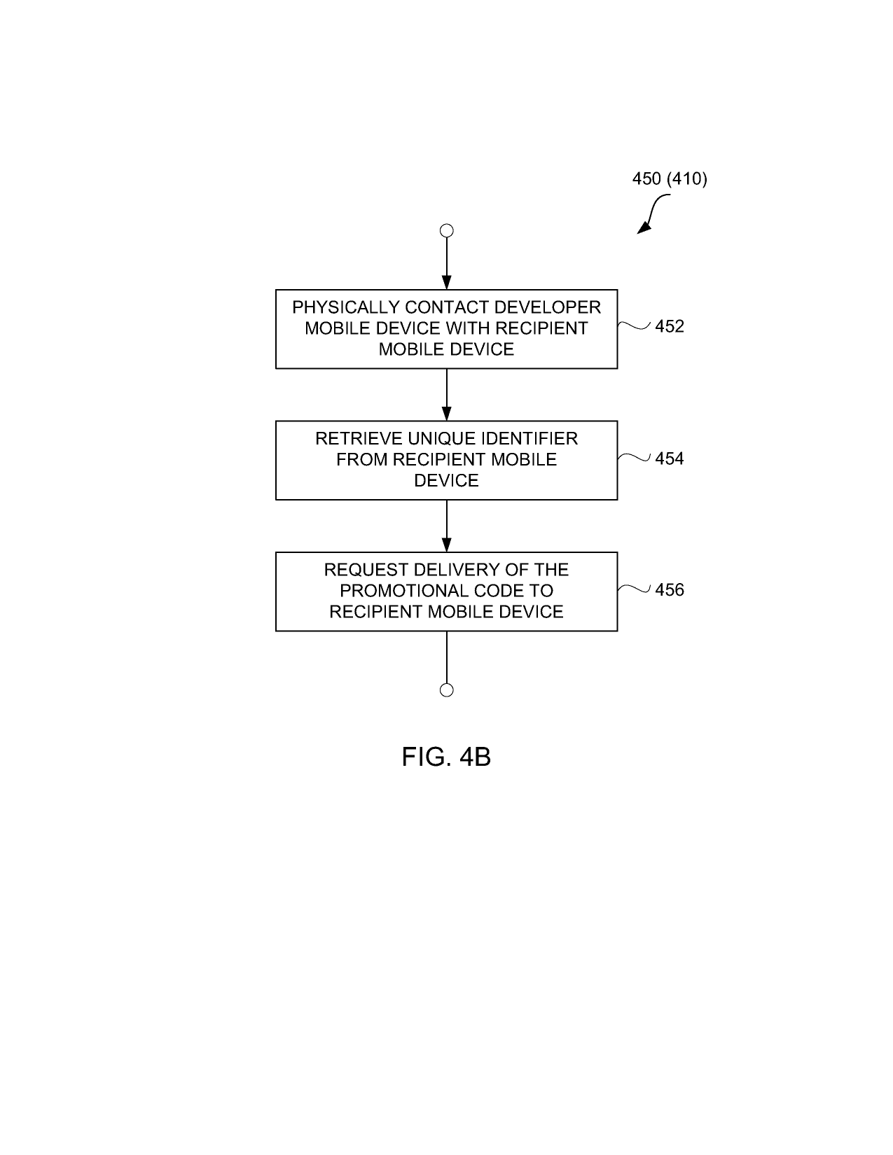

FIG. 4A is a flow diagram of a promotional code access process 400 according to one embodiment. The promotional code access process 400 is, for example, performed by a computing device associated with a developer of an application program. As an example, with respect to FIG. 2, the promotional code access process 400 can be carried out by the stationary device 206 or the mobile device 208-1, which are exemplary computing devices associated with the developer of the application program.

The promotional code access process 400 can submit 402 an application program to a network-based distribution system for distribution. For example, the network-based distribution system can be implemented at least in part by the application management server 202 illustrated in FIG. 2. Typically, the submission is from the computing device associated with the developer through one or more networks to the network-based distribution system.

Once the application program has been submitted 402, the network-based distribution system can review the application program for various criteria, including quality, operability, and/or content. If the network-based distribution system concludes that the submitted application program is acceptable for distribution, the application program can be made available for distribution by the network-based distribution system. In one embodiment, an online store is associated with the network-based distribution system and can be used to facilitate distribution of the application program.

After the application program has been submitted 402 and approved for distribution, the network-based distribution system can allow the associated developer to obtain one or more promotional codes that can be distributed to other users or devices by the developer. More particularly, the promotional code access process 400 can request 404 one or more promotional codes. Here, the developer (e.g., the computing device of the developer—the developer computing device) can request 404, the one or more promotional codes from the network-based distribution system. Then, a decision 406 can determine whether the one or more promotional codes have been received. When the decision 406 determines that the one or more promotional codes have not yet been received, the promotional code access process 400 can await receipt of such codes or a notification that the codes are unavailable. If the one or more promotional codes that have been requested 404 are not available, the developer can be notified and the promotional code access process 400 can end (not shown).

Once the decision 406 determines that the one or more promotional codes have been received, a decision 408 can determine whether the developer (e.g., the developer computing device) desires to distribute at least one of the promotional codes. When the decision 408 determines that at least one of the promotional codes is to be distributed, the promotional code access process 400 can initiate 410 delivery of a promotional code to a recipient mobile device that is positioned proximate to the developer computing device. The proximity of the recipient mobile device to the developer mobile device serves to enable the recipient mobile to be identified. Once identified, the delivery of the promotional code to the recipient mobile device can be achieved in a wireless manner.

Once the delivery is initiated 410, the delivery can be completed, whereby the at least one promotional code is made available to the recipient mobile device. Thereafter, a decision 412 can determine whether the promotional code access process 400 should continue. For example, the developer of the application program may desire that the promotional code access process 400 continue so that additional promotional codes can be distributed. Hence, when the decision 412 determines that the promotional code access process should continue, the promotional code access process 400 can return to repeat the decision 408 and subsequent blocks so that additional promotional codes can be distributed. Alternatively, when the decision 412 determines that the promotional code access process should not continue, the promotional code access process 400 can end. Also, when the decision 408 determines that at least one of the promotional codes is not to be distributed, the promotional code access process 400 can bypass initiation 410 of delivery of a promotional code to a recipient mobile device.

FIG. 4B is a flow diagram illustrating a recipient identification process 450 according to one embodiment. The recipient identification process 450 can represent at least a portion of the processing performed at block 410 of the promotional code access process 400 which initiates delivery of a promotional code to a recipient mobile device that is positioned proximate to a developer computing device.

The recipient identification process 450 can involve physical contact 452 between the developer mobile device and the recipient mobile device. In this embodiment, proximity is evaluated by physical contact. The physical contact can involve a bumping or tapping between the two mobile devices. Through use of accelerometers in the mobile devices, the mobile devices are able to determine which precise mobile devices are being physically contacted. In addition, during or after the physical contact 452, a unique identifier can be retrieved 454 from the recipient mobile device. In one embodiment, during or following the physical contact 452, the developer mobile device is able to retrieve 454 a unique identifier associated with the recipient mobile device. The unique identifier can be an assigned device identifier, a telephone number, a network address, username, a user account, etc. or any combination of such data. Access to the unique identifier can be achieved directly by a peer-peer exchange of such information (e.g., near field communication), or by exchange of such information via a local network (WiFi, piconet (e.g., Bluetooth), etc.). Additionally, the recipient identification process 450 can then request 456 delivery of the promotional code to the recipient mobile device. Hence, the receipt identification process 450 can serve to uniquely identifier of the recipient mobile device so that the promotional code destined for the recipient mobile device can be properly delivered.

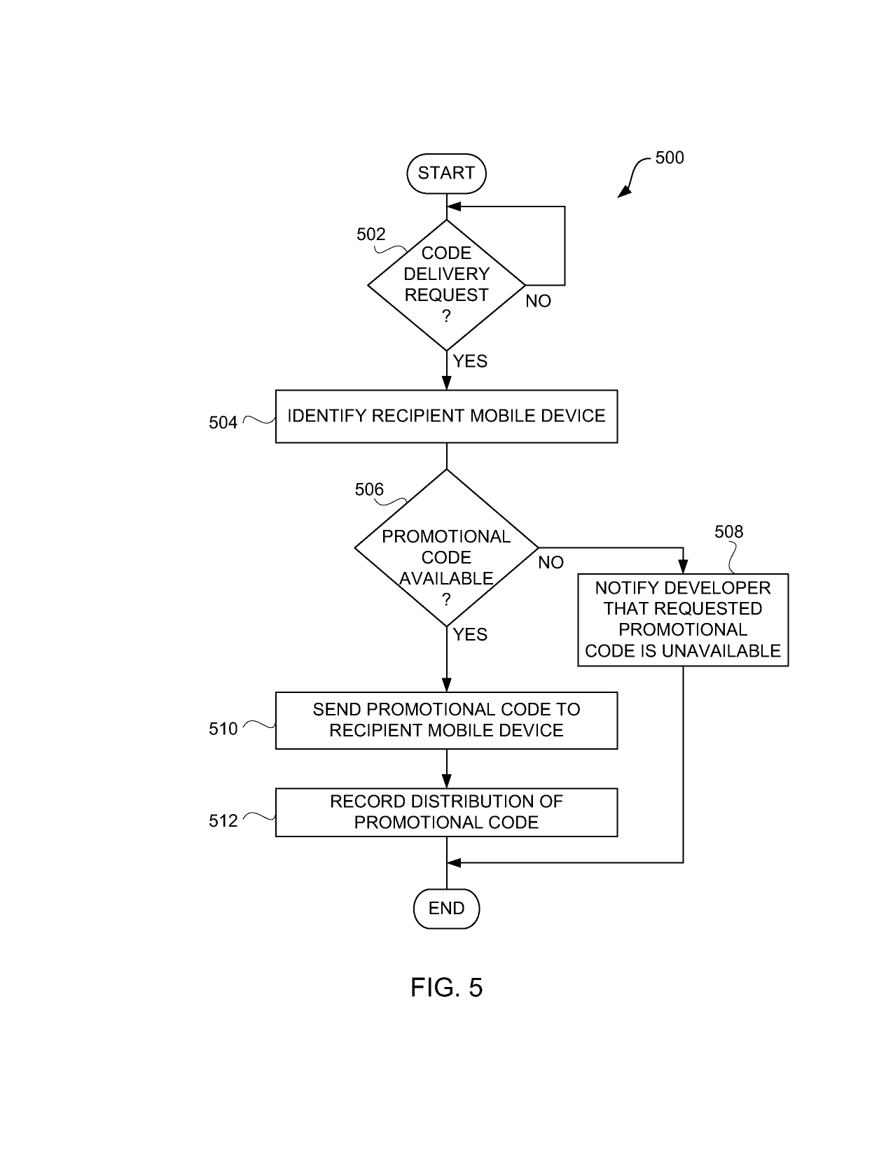

FIG. 5 is a flow diagram illustrating a promotional code delivery process 500 according to one embodiment. The promotional code delivery process 500 can, for example, be performed by an application management server, such as the application management server 202 illustrated in FIG. 2.

The promotional code delivery process 500 can include a decision 502 that determines whether a promotional code delivery request has been received. When the decision 502 determines that a promotional code delivery request has not been received, the promotional code delivery process 500 can await such a request. Once the decision 502 determines that a promotional code delivery request has been received, the recipient mobile device that is to receive the promotional code can be identified 504. In one embodiment, the recipient mobile device can be identified by or using information included within the promotional code delivery request. For example, the promotional code delivery request can include at least a unique identifier for the recipient mobile device.

After the recipient mobile device has been identified 504, a decision 506 can determine whether a promotional code is available. Here, the promotional code to be distributed is associated with a particular application program that is made available by way of the promotional code. Typically, for a given application program (or given developer), the quantity of promotional codes that can be distributed (e.g., by the developer) are limited. For example, the application management server could limit the quantity of promotional codes available for a given application program to fifty (50). Hence, if the developer has already distributed all of the available promotional codes for the particular application program, the promotional code delivery request could be denied. Hence, when the decision 506 determines that there are no promotional codes available to distribute for the application program, the promotional code delivery process 500 can notify 508 the developer that the requested promotional code is unavailable. Thereafter, the promotional code delivery process 500 can end.

On the other hand, when the decision 506 determines that the promotional code being requested is available, the promotional code can be sent 510 to the recipient mobile device. Typically, the sending of the promotional code to the recipient mobile device involves wireless transmission of the promotional code to the recipient mobile device, such as through one or more networks (e.g., cellular, SMS, WiFi, etc.). After the promotional code has been sent 510, the distribution of the promotional code can be recorded 512. Here, the recording of the distribution of the promotional code serves to manage the distribution of promotional codes, and also to record and maintain a count of the number of promotional codes that have been consumed, which can be important if the quantity of available promotional codes is limited or monitored. Following the recordation 512 of the distribution of the promotional code, the promotional code delivery process 500 can end.

Further, in one embodiment, before the promotional code is sent 510 to the recipient mobile device, the promotional code delivery process 500 can determine whether the recipient associated with the recipient mobile device has a user account. For example, it can be determined whether the recipient has a user account with an online store associated with the application management server. If it is determined that the recipient does have an account, then the promotional code can be sent 510 to the recipient mobile device. Alternatively, if it is determined that the recipient does not have an account, then the promotional code can not be sent 510 to the recipient mobile device, and the developer mobile device and/or the recipient mobile device could be notified that the sending of the promotional code is declined.

Additionally, in one embodiment, before the promotional code is sent 510 to the recipient mobile device, the promotional code delivery process 500 can determine whether the given application program is suitable for operation on the recipient mobile device. For example, the decision can determine whether the given application would be compatible with hardware and software of the recipient mobile device. If the decision determines that the given application program is suitable for operation (e.g., compatible) on the recipient mobile device, then the promotional code can be sent 510 to the recipient mobile device. Alternatively, if the decision determines that the given application program is not suitable for operation (e.g., not compatible) on the recipient mobile device, then the promotional code can not be sent 510 to the recipient mobile device, and the developer mobile device and/or the recipient mobile device could be notified that the sending of the promotional code is declined.

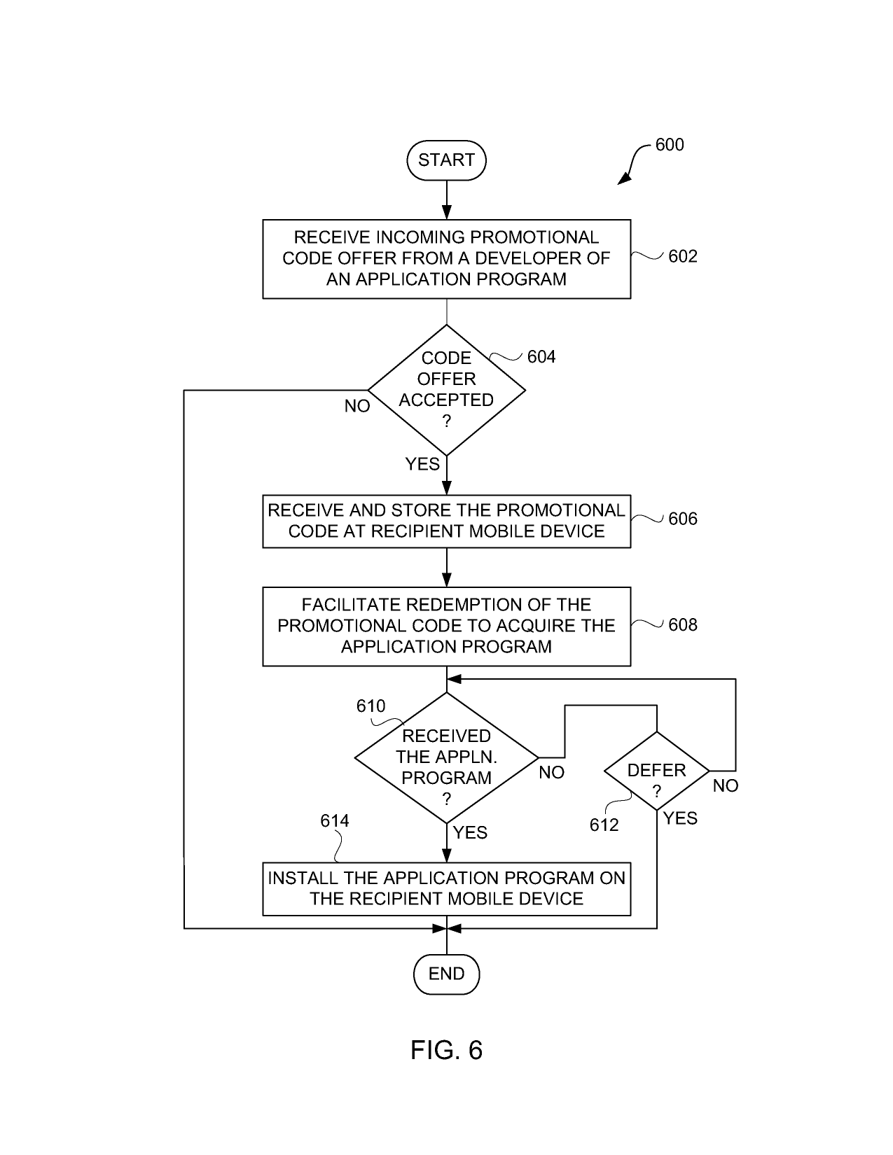

FIG. 6 is a flow diagram of a promotional code redemption process 600 according to one embodiment. The promotional code redemption process 600 can, for example, be performed by a computing device, such as a mobile device associated with a recipient.

The promotional code redemption process 600 can receive 602 an incoming promotional code offer from the developer of an application program. The incoming promotional code being received 602 can be delivered by a computing device associated with the developer or can be delivered by an application management server (e.g., the application management server 202 illustrated in FIG. 2).

Next, a decision 604 can determine whether the promotional code offer has been accepted. Here, the recipient (e.g., the recipient computing device) can operate to accept or decline the incoming promotional code offer. When the incoming promotional code offer is declined, the promotional code redemption process 600 can end since there is no promotional code transfer.

On the other hand, when the decision 604 determines that the incoming promotional code offer is accepted, the promotional code can be received and stored 606 at the recipient mobile device (e.g., the mobile device 208-2 illustrated in FIG. 2). Next, the promotional code redemption process 600 can facilitate 608 redemption of the promotional code to acquire the application program. Here, computer program code and/or graphical user interfaces can be provided and can operate on the recipient mobile device to assist the recipient in redeeming the promotional code. In one implementation, the redemption can be performed substantially or completely automatic (i.e., with little or no user input). For example, the recipient need know or enter the promotional code to be redeemed.

Once the promotional code has been submitted for redemption, a decision 610 can determine whether the application program associated with the promotional code has been received. Here, in this embodiment, in response to the submission of the promotional code, the recipient is entitled to receive the application program, typically at no charge. Hence, the decision 610 of the promotional code redemption process 600 can determine whether the application program has been received. When the decision 610 determines that the application program has not yet been received, a decision 612 can determine whether the receipt of the application program should be deferred. The receipt of the application program can be deferred due to network bandwidth restrictions or unavailability or can be deferred due to the recipient's desires. In any event, when the decision 612 determines that the receipt of the application program should be deferred, the promotional code redemption process 600 can end.

Alternatively, when the decision 612 determines that the receipt of the application program should not be deferred, the promotional code redemption process 600 can return to repeat the decision 610 so that the application program can be received. In one embodiment, the application program will not be received if the promotional code was not authentic and valid or if the recipient is otherwise not permitted to receive the application program. In any event, if the decision 610 determines that the application program has been received, the application program can be installed 614 on the recipient mobile device. Here, the installation 614 can occur substantially or completely automatic (i.e., with little or no user input). For example, the recipient need participate in the application program being received or being installed, though the recipient could be requested to confirm approval for installation and/or be notified of successful receipt or installation of the application program. Following the installation 614 of the application program, the promotional code redemption process 600 can end.

Additionally, in one embodiment, in redeeming the promotional code, the application management server which processes the redemption request can not only verify the authenticity of the received promotional code but also determines whether the application program is suitable for operation on the recipient mobile device. For example, the decision can determine whether the application program would be compatible with hardware and software of the recipient mobile device. If it is determined that the application program is suitable for operation (e.g., compatible) on the recipient mobile device, then the application program associated with promotional code can be sent to the recipient mobile device which receives the application program at the decision 610. Alternatively, if it is determined that the application program is not suitable for operation (e.g., not compatible) on the recipient mobile device, then the application program can not be sent to the recipient mobile device, and the developer mobile device and/or the recipient mobile device could be notified that the sending of the application program is declined.

Still further, in one embodiment, the installation 614 of the application can be dependent on whether the application program is suitable for use on the recipient mobile device. In other words, after the decision 610 determines that the application program has been received, the promotional code redemption process 600 can evaluate whether the application program is suitable for use on the recipient mobile device. For example, the evaluation of suitability for use can determine whether the application would be compatible with hardware and software of the recipient mobile device. In the event that the evaluation of suitability for use indicates that the application program is not suitable for use, the promotional code redemption process 600 can decline to install 614 the application program on the recipient mobile device.

In another embodiment, the application program being distributed can include in-application features/enhancements that can be subsequently purchased by the recipient. In such cases, the developer in providing a promotional code may desire to also grant one or more in-application features/enhancements to the recipient when the application program is provided in response to submission of a promotional code, so that the recipient is not later required to pay money to gain access to the one or more in-application features/enhancements. The developer can control access to the one or more in-application features/enhancements in any of various ways. In one example, on requesting promotional codes, the developer can request that the promotional codes being requested include access to one or more in-application features/enhancements, which could be separately approved if desired. In another example, when a recipient is identified for distribution of a promotional code, the developer could provide user input to the developer mobile device to indicate which, if any, of the one or more in-application features/enhancements the particular recipient should gain access to (without cost). In still another example, the developer could following download of the application program to the recipient subsequently authorize the recipient to gain access to one or more in-application features/enhancements.

Embodiments of the invention as discussed herein can use electronic devices, such as computing devices. However, the invention is particularly well suited for mobile devices (i.e., mobile electronic devices), such as a handheld electronic device or mobile computers. One example of a handheld electronic device is a mobile telephone (e.g., cell phone) or Personal Digital Assistant (PDA). One example of a mobile telephone is the iPhone® mobile telephone, which is available from Apple Inc. of Cupertino, Calif. Some examples of mobile computers are tablet computer, notebook computer or netbook computer. One example of a tablet computer is the iPad° tablet computer, which is available from Apple Inc. of Cupertino, Calif.

The various aspects, embodiments, implementations or features of the invention can be used separately or in any combination.

In view of the foregoing, it will readily be known that an electronic device provided in accordance with one or more embodiments can, for example, be a computing device (e.g., personal computer), mobile phone (e.g., cellular phone, smart phone), personal digital assistant (PDA), media player (e.g., music, videos, games, images), media storage device, camera, and/or the like. An electronic device may also be a multi-functional device that combines two or more of these device functionalities into a single device. A portable electronic device may support various types of network communications.

A portable electronic device can be provided as a hand-held electronic device. The term hand-held can generally refer to an electronic device with a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Although promotional codes for application programs were discussed above, the promotional codes can be for any digital assets. In one embodiment, the digital assets are application programs. In another embodiment, the digital assets are digital media assets. The digital media assets (e.g., digital media items) can, for example pertain to video items (e.g., video files or movies), audio items (e.g., audio files or audio tracks, such as for songs, musical albums, podcasts or audiobooks), or image items (e.g., photos).

The invention can be implemented by software, hardware, or a combination of hardware and software. The invention can also be embodied as computer readable code on a computer readable medium. The computer readable medium, which is non-transitory, is any data storage device that can store data which can thereafter be read by a computer system. Examples of the computer readable medium generally include read-only memory and random-access memory. More specific examples of computer readable medium are tangible (and non-transitory) and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of various embodiments of the invention are numerous. Different aspects, embodiments or implementations may, but need not, yield one or more of the following advantages. One advantage of at least some embodiments is that power consumption of an electronic device can be reduced through adaptive frame rate control. Another advantage of at least some embodiments is that an application program operating on an electronic device can itself decide how to effectively reduce frame rate without substantially impacting output display quality. Still another advantage of at least some embodiments is that through intelligent frame rate control battery usage times for a portable electronic device are extended.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for distribution of application programs, the method comprising:
submitting an application program to a network-based distribution system, the application program being submitted by a developer;
obtaining, from the network-based distribution system, a code for distributing a copy of the application program to a recipient; and
initiating wireless delivery of the code from a developer mobile device to the recipient mobile device, the initiating including at least detecting that the developer mobile device and to the recipient mobile device are physically proximate to one another.

2. A method as recited in claim 1, wherein the code is a promotional code that is associated with the application program prior to delivery to the recipient mobile device.

3. A method as recited in claim 1, wherein the detecting that the developer mobile device and the recipient mobile device are physically proximate to one another requires that the developer mobile device be adjacent the recipient mobile device.

4. A method as recited in claim 1, wherein the detecting that the developer mobile device and the recipient mobile device are physically proximate to one another requires that the developer mobile device be in physical contact with the recipient mobile device.

5. A method as recited in claim 1, wherein the detecting that the developer mobile device and the recipient mobile device are physically proximate to one another requires that the developer mobile device be in at least momentary physical contact with the recipient mobile device.

6. A method as recited in claim 1, wherein the detecting that the developer mobile device and the recipient mobile device are physically proximate to one another comprises detecting that a bump between the developer mobile device and the recipient mobile device has occurred.

7. A method as recited in claim 1, wherein the method comprises:
wirelessly delivering the code to the recipient mobile device by the network-based distribution.

8. A method as recited in claim 1, wherein the method comprises:
delivering the code to the recipient mobile device from the developer mobile device.

9. A method as recited in claim 1, wherein the method comprises:
determining whether the recipient or the recipient mobile device has authorized the receipt of the code for the application program;
determining whether the application program is suitable for operation on the recipient mobile device; and
delivering the code to the recipient mobile device.

10. A method as recited in claim 9, wherein the delivering of the code to the recipient mobile device is only done if the determining has determined that the recipient or the recipient mobile device has authorized the receipt of the code for the application program and if the determining has determined that the application program is suitable for operation on the recipient mobile device.

11. A method as recited in claim 1, wherein the method comprises:
determining whether the recipient or the recipient mobile device has authorized the receipt of the code for the application program; and
delivering the code to the recipient mobile device provided that the determining has determined that the recipient or the recipient mobile device has authorized the receipt of the code for the application program.

12. A method as recited in claim 1, wherein the method comprises:
determining whether the application program is compatible with hardware and software of the recipient mobile device; and
delivering the code for the application program to the recipient mobile device provided that the determining has determined that the application program is compatible with hardware and software of the recipient mobile device.

13. A method as recited in claim 1, wherein the method comprises:
determining whether the recipient has a user account with the network-based distribution; and
delivering the code to the recipient mobile device provided that the determining has determined that the recipient has a user account with the network-based distribution.

14. A method as recited in claim 1,
wherein the application program includes at least one in-application feature/enhancement that can be accessed in a separately controlled manner, and
wherein the method further comprises:
determining whether the recipient or the recipient mobile device is to receive access to the at least one in-application feature/enhancement with the code being delivered to the recipient mobile device.

15. A method for distribution of application programs, the method comprising:
submitting an application program to a network-based distribution system, the application program being submitted by a developer;
obtaining, from the network-based distribution system, a code for distributing a copy of the application program to a recipient; and
initiating wireless delivery of the code from a developer mobile device to the recipient mobile device, the initiating including at least physically bumping the developer mobile device with the recipient mobile device.

16. A method as recited in claim 15, wherein the code is a promotional code that enables the recipient to acquire the application program prior at no cost.

17. A method for distribution of digital asset to a mobile device, the method comprising:
detecting that a developer mobile device is physically proximate to a recipient mobile device, the developer mobile device being associated with a developer of an application program;
receiving a code from a developer of an application program, where the developer mobile device is or has been physically proximate to the recipient mobile device;
determining whether a recipient agrees to receive the code for access to a copy of the application program being provided by the developer;
receiving and storing the code at the recipient mobile device provided that the determining determines that the recipient has agreed to receive the code associated with the application program and provided that the detecting detects that the developer mobile device and the recipient mobile device are or were physically proximate to each other;
subsequently facilitating redemption of the code with the network-based distribution system to acquire the application program; and
thereafter receiving and installing the application program at the recipient mobile device.

18. A method as recited in claim 17, wherein the code is a promotional code that is associated with the application program prior to the receiving and storing of the code at the recipient mobile device.

19. A method as recited in claim 17, wherein the method comprises:
determining whether the recipient has an account with the network-based distribution system; and
preventing at least the receiving and installing of the application program at the recipient mobile device if the determining determines that the recipient does not have an account with the network-based distribution system.

20. A method as recited in claim 17, wherein the detecting that the developer mobile device is physically proximate to the recipient mobile device detects that the developer mobile device is adjacent to the recipient mobile device.

21. A method as recited in claim 17, wherein the detecting that the developer mobile device is physically proximate to the recipient mobile device detects that the developer mobile device is in physical contact with the recipient mobile device.

22. A method as recited in claim 17, wherein the detecting that the developer mobile device is physically proximate to the recipient mobile device detects that the developer mobile device is in momentary physical contact with the recipient mobile device.

23. A method as recited in claim 17, wherein the detecting that the developer mobile device is physically proximate to the recipient mobile device detects that the developer mobile device has bumped with the recipient mobile device.

24. A method for distribution of digital asset to a mobile device, the method comprising:
receiving a physical bump at recipient mobile device from a developer mobile device associated with a developer of an application program;
determining that a recipient has an account with the network-based distribution system;
determining whether the recipient agrees to receive a promotional code being provided by the developer;
storing the promotional code at the recipient mobile device;
subsequently facilitating redemption of the promotional code with the network-based distribution system, provided that the recipient has an account with the network-based distribution system, and provided that the recipient has agreed to receive the promotional code; and
thereafter receiving and installing the application program at the recipient mobile device.

25. A non-transitory computer readable medium including at least computer program code stored thereon for distribution of application programs, the computer readable medium comprising:
computer program code for submitting an application program to a network-based distribution system, the application program being submitted by a developer;
computer program code for obtaining, from the network-based distribution system, a code for distributing a copy of the application program to a recipient; and
computer program code for initiating wireless delivery of the code from a developer mobile device to the recipient mobile device, the initiating including at least detecting that the developer mobile device and to the recipient mobile device are physically proximate to one another.

26. A non-transitory computer readable medium including at least computer program code stored thereon for distribution of digital asset to a mobile device, the computer readable medium comprising:
computer program code for detecting that a developer mobile device is physically proximate to a recipient mobile device, the developer mobile device being associated with a developer of an application program;
computer program code for receiving a code from a developer of an application program, where the developer mobile device is or has been physically proximate to the recipient mobile device;
computer program code for determining whether a recipient agrees to receive the code for access to a copy of the application program being provided by the developer;
computer program code for receiving and storing the code at the recipient mobile device provided that the determining determines that the recipient has agreed to receive the code associated with the application program and provided that the detecting detects that the developer mobile device and the recipient mobile device are or were physically proximate to each other;
computer program code for subsequently facilitating redemption of the code with the network-based distribution system to acquire the application program; and
computer program code for receiving and installing the application program at the recipient mobile device.
